(19) United States
(12) Patent Application Publication
(10) Pub. No.: US 2020/0087963 A1
(43) Pub. Date: Mar. 19, 2020

(54) Double Headed Spring Winding Cone

(71) Applicant: Lawrence Schumacher, Menifee, CA (US)

(72) Inventor: Lawrence Schumacher, Menifee, CA (US)

(21) Appl. No.: 16/133,904

(22) Filed: Sep. 18, 2018

(51) Int. Cl. E05D 13/00; E06B 9/62

(52) U.S. Cl. CPC E05D 13/12; E05Y 2900/106; E06B 9/62

(57) ABSTRACT

My invention is a unique component installed onto the ends of torsion springs that adds four additional winding holes and permits the winding and unwinding (tensioning and de-tensioning) of torsion springs in situations where adjacent obstructions would otherwise disallow the normal means of this process while using normal trade tools. Under these limited access conditions, torsion springs that are fitted with the Double Headed Spring Winding Cone would be most desirable when new doors are installed and when old springs on existing doors need replacing.

### CROSS-REFERENCE TO RELATED APPLICATIONS

Donkey Cone marketed as “patent pending” by Jeff Gabelsberg at http://donkeycone.com/. Coil Torsion Spring Mounting Cones by Kalister & Nieman U.S. Pat. No. 4,817,927, Apr. 4, 1989. Winding cone of an overhead door by John E. Scates, Windsor Door Inc., App/Pub No. U.S. Ser. No. 09/234,616, Jan. 1, 1999 and App/Pub No. &S6263541B1, Jul. 24, 2001. Ratcheting winding cone by Willis D. Miller, CHI Overhead Doors Inc., App/Pub No. U.S. Ser. No. 10/097,668, Mar. 13, 2002 and App/Pub No. U.S. Pat. No. 6,735,905B1, May 18, 2004.

### BACKGROUND OF THE INVENTION

This invention relates to torsion springs of the type used to counter balance segmented garage doors of various types; specifically, the winding cones, that are attached to them and used to wind and unwind them.

In certain cases where ceilings above torsion springs are lower than normal, or when home owners or builders install shelving, utility runs, beams, door struts or other permanent obstructions directly above and/or adjacent to torsion springs, the space normally required to wind and unwind torsion springs using conventional winding rods is impeded, making it impossible to wind and unwind them. The Double Headed Spring Winding Cone was invented to address this low clearance, or minimal access issue when using conventional winding rods.

Further objects and advantages of my invention will become apparent through consideration of the drawings and ensuing description.

### BRIEF SUMMARY OF THE INVENTION

The winding and unwinding of torsion springs is not necessarily an arduous task under normal conditions, provided that adequate overhead room is available to move the winding rods the required 90 degrees of motion, and does not require special equipment to do so. Historically this has been accomplished through the use of steel winding rods of adequate length by rotating the spring one quarter turn, or 90 degrees, at a time until the spring is wound or unwound. In some cases clearance above, under, or behind springs is limited and a full 90 degrees of turn can not be achieved. In cases likes these the installer must use dangerously shortened or modified winding rods or manually lift the door and pre-load the springs.

The normal process of winding or unwinding torsion springs is accomplished by placing the end of one of the two winding rods into one of four winding holes, spaced 90 degrees apart, in the end of the torsion spring. The winding rod is then moved upward toward the ceiling, in the case of winding, or lowered, in the case of unwinding. While holding this tension, the second winding rod is then inserted into the next exposed hole on the end of the torsion spring and it is then lifted toward the ceiling, thus transferring the winding force to the second winding rod. Once this load is transferred to the second winding rod the first winding rod can be removed from the torsion spring. This process is then repeated a certain number of times as required to fully wind the torsion spring. In situations where a full 90 degrees of motion of the winding rods can not be accomplished, access to the second available winding hole is not possible. The Double Headed Spring Winding Cone, by adding four more winding holes, each spaced 45 degrees from one another, permits for a shorter distance of winding rod motion and allows for full access to the next winding hole.

The Double Headed Spring Winding Cone is a cone that attaches to the end of a torsion spring and adds four more winding holes, for a total of eight holes, each spaced 45 degrees from one another, thus permitting 45 degrees of turn.

### BRIEF DESCRIPTION OF THE SEVERAL VIEWS OF THE DRAWING

FIG. 1: Front view. This view shows the Double Headed Spring Winding Cone positioned vertically showing the winding holes (20), the spring mounting tabs (22) used to twist the cone into the torsion spring, a threaded set screw hole (24), the support bridges (26) and the tapered threaded cone base (28) that is inserted into the end of the torsion spring.

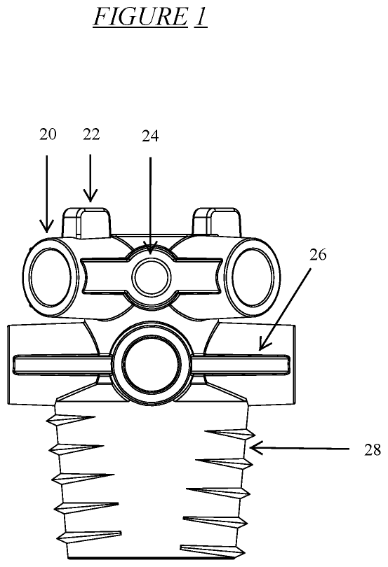

FIG. 2: Right side view. This view shows the Double Headed Spring Winding Cone positioned vertically showing the winding holes (20), the spring mounting tabs (22) used to twist the cone into the torsion spring, the support bridges (26) and the tapered threaded cone base (28) that is inserted into the end of the torsion spring.

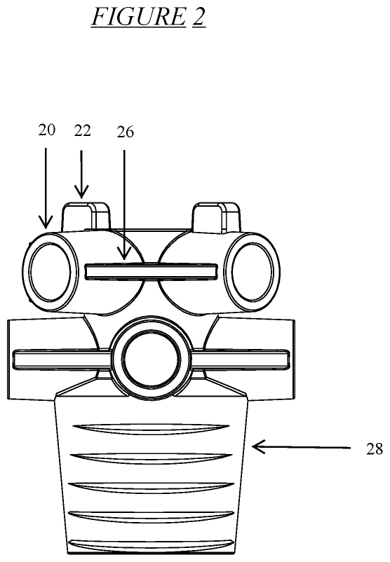

FIG. 3: Top view. This is a view of the top of the Double Headed Spring Winding Cone showing the winding holes (20), the spring mounting tabs (22) used to twist the cone into the torsion spring, the support bridges (26) and the 1″ diameter hole (30) through which a torsion rod is inserted.

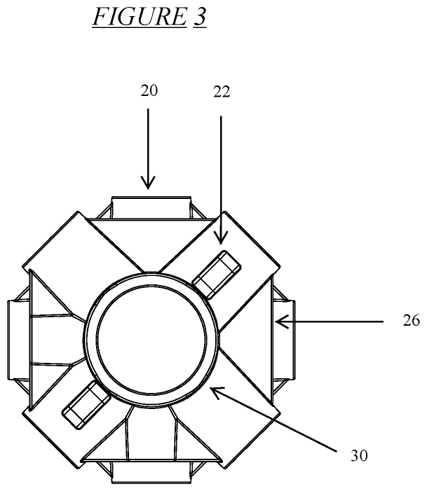

FIG. 4: Bottom view. This view shows the cone from its bottom which is where a torsion spring is attached and shows the winding holes (20), the support bridges (26), the tapered threaded cone base (28) that is inserted into the end of the torsion spring, and the 1″ diameter hole (30) through which a torsion rod is inserted.

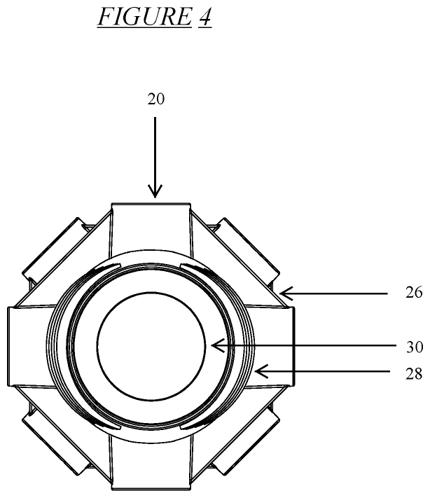

FIG. 5: Top 3D view. This three dimensional view from the top shows the Double Headed Spring Winding Cone positioned vertically showing the winding holes (20), the spring mounting tabs (22) used to twist the cone into the torsion spring, a threaded set screw hole (24), the support bridges (26), the tapered threaded cone base (28) that is inserted into the end of the torsion spring, and the 1″ diameter hole (30) through which a torsion rod is inserted.

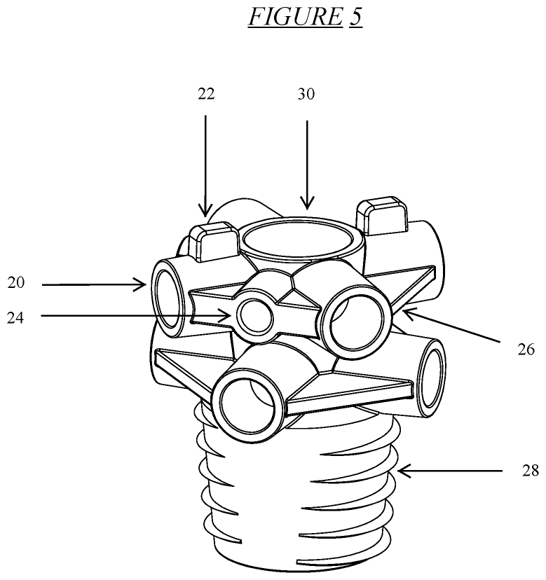

FIG. 6: Bottom 3D view. This three dimensional view from the bottom shows the Double Headed Spring Winding Cone positioned vertically showing the winding holes (20), the spring mounting tabs (22) used to twist the cone into the torsion spring, a threaded set screw hole (24), the support bridges (26) and the tapered threaded cone base (28) that is inserted into the end of the torsion spring.

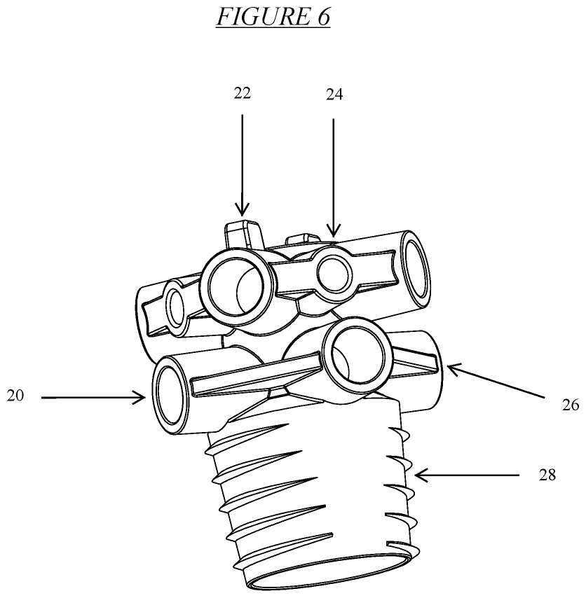

FIG. 7: Top view with set screws. This is a view of the top of the Double Headed Spring Winding Cone showing the winding holes (20), the spring mounting tabs (22) used to twist the cone into the torsion spring, the support bridges (26), the 1″ diameter hole (30) through which a torsion rod is inserted and the square-headed threaded set screws (32).

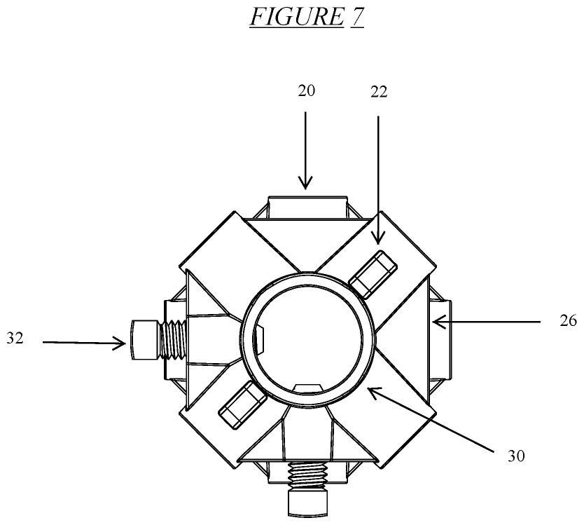

FIG. 8: Front spring & cone view. This view shows the Double Headed Spring Winding Cone positioned vertically as attached to a torsion spring showing the winding holes (20), the spring mounting tabs (22) used to twist the cone into the torsion spring, the support bridges (26), the square-headed threaded set screws (32) and the attached torsion spring (34).

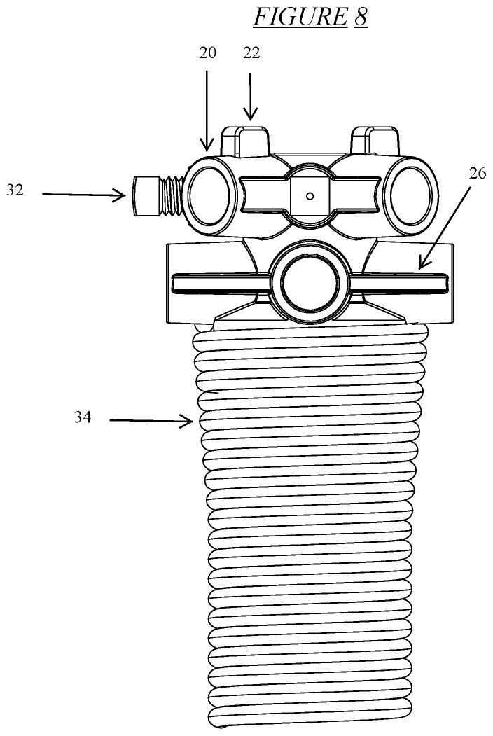

FIG. 9: Top Front 3D spring & cone view. This three dimensional view from the top front shows the Double Headed Spring Winding Cone attached to a torsion spring and positioned vertically showing the winding holes (20), the spring mounting tabs (22) used to twist the cone into the torsion spring, the square-headed threaded set screws (32), the support bridges (26), the 1″ diameter hole (30) through which a torsion rod is inserted, and the attached torsion spring (34).

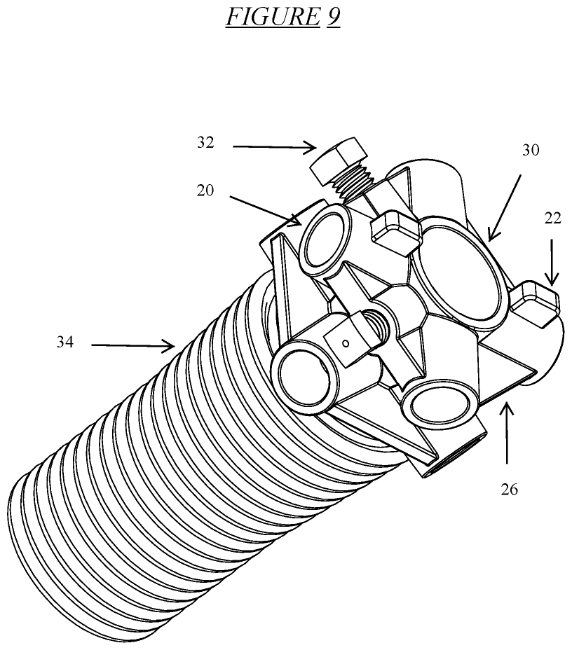

### DETAILED DESCRIPTION OF THE INVENTION

The industrial process of metal injection molding or sand casting would be the processes used to form the basic shape of the Double Headed Spring Winding Cone, using aluminum or other suitably strong materials. After the basic shape is formed it would then be machined using normal milling processes to create the holes and threads needed to finalize the end product.

After the cone is manufactured it is then installed by the torsion spring manufacturer onto various sized torsion springs by twisting it into the end of the torsion spring whereby it then becomes securely attached and unremovable. The opposite end of each torsion spring receives a different type of cone that creates the mounting means of the finished torsion spring assembly which then creates the means of keeping it immovable when bolted to a bracket that is secured to the adjoining header beam over a garage door opening. Once installed on a garage door the newly manufactured torsion spring assembly can then be wound, or tensioned, by the normal method using winding bars, or rods.

All previous torsion spring winding cones, regardless of how they are secured to torsion springs, historically have only had 4 winding holes that are spaced 90 degrees apart. Under circumstances when the clearance needed to move each winding rod the necessary 90 degrees is reduced by low ceilings, utility runs, support beams, door struts, shelving, or other obstructions, it becomes clear to the installer that by having 8 winding holes that are spaced 45 degrees apart would be the torsion spring of choice to install.

I claim the following:

1. A torsion spring adjustment cone comprised of aluminum, steel or other suitable material using traditional casting, injection molding and machining methods, for the purposes of winding, unwinding, loading or unloading torsion springs under limited clearance conditions and having a threaded conical base (28) to fit into the end of various diameter spring sizes (34).

2. Said torsion spring adjustment cone includes 8 winding holes (20) around the circumference of the winding cone and comprised of 2 groups of 4 holes each around the circumference of the winding cone and placed on parallel planes, with each plane being offset 45 degrees from one another around its circumference.

3. Said torsion spring adjustment cone having 2 each threaded holes (24) placed 90 degrees from one another on opposite sides of a winding hole on either of said parallel planes for set screws (32) to secure the winding cone to a torsion spring rod placed through its center.
